(19) United States
(12) Patent Application Publication
(10) Pub. No.: US 2017/0115698 A1
(43) Pub. Date: Apr. 27, 2017

(54) DISPLAY DEVICE

(71) Applicant: Samsung Display Co., Ltd., Yongin-si (KR)

(72) Inventors: Dae Ho LEE, Seoul (KR); Seong Gyu KWON, Suwon-si (KR)

(21) Appl. No.: 15/208,464

(22) Filed: Jul. 12, 2016

(30) Foreign Application Priority Data
Oct. 21, 2015 (KR) 10-2015-0146972

(51) Int. Cl. G06F 1/16; G02F 1/1339; G02F 1/1335; G09G 3/36; G02F 1/1333

(52) U.S. Cl. CPC G06F 1/1647; G09G 3/36; G02F 1/133377; G02F 1/133305; G02F 1/133514; G02F 1/1339; G06F 1/1686; G06F 1/1626; G02F 2201/123; G02F 2201/121

(57) ABSTRACT

Provided is a display device. The display device includes a mobile device and a cover connected thereto, in which the cover includes a contact pad portion and a display unit that are connected with an external power supply. The display unit includes a flexible substrate, a pixel electrode positioned on the flexible substrate, a roof layer facing the pixel electrode, and a liquid crystal layer formed by a plurality of microcavities including liquid crystal molecules between the pixel electrode and the roof layer, and the cover is connected to a surface of the mobile device to cover the front surface and the rear surface of the mobile device.

### CROSS-REFERENCE TO RELATED APPLICATION

This application claims priority to and the benefit of Korean Patent Application No. 10-2015-0146972 filed in the Korean Intellectual Property Office on Oct. 21, 2015, the entire contents of which are incorporated herein by reference.

### BACKGROUND

(a) Technical Field

The present disclosure relates to a display device.

(b) Description of the Related Art

Generally, mobile communication terminals that are formed in a slim type, such as mobile phones, personal digital assistants (PDAs), and portable personal computers (PCs), are designed to function internationally, that is, to perform various computer operations by wireless communication according to reception and network access almost regardless of place and time.

It is popular for users of the mobile devices to apply cover cases for protecting their devices.

The above information disclosed in this Background section is only for enhancement of understanding of the background of the present disclosure and therefore may contain information that does not form the prior art that is already known in this country to a person of ordinary skill in the art.

### SUMMARY

The present disclosure provides a display device having an advantage of extending a display area.

An exemplary embodiment of the present disclosure provides a display device including: a mobile device and a cover connected thereto, in which the cover includes a contact pad portion and a display unit that are connected with an external power supply. The display unit includes a flexible substrate, a pixel electrode positioned on the flexible substrate, a roof layer facing the pixel electrode, and a liquid crystal layer formed by a plurality of microcavities including liquid crystal molecules between the pixel electrode and the roof layer, and the cover is connected to a surface of the mobile device to cover the front surface and the rear surface of the mobile device.

The cover may cover the front surface, the side, and a part of the rear surface of the mobile device, and the display unit may be positioned on the inner surface of the cover.

The mobile device may be configured to display a first portion of an image, and the display unit may be configured to display a second portion of the image such that visual continuity between the two image portions is maintained.

The cover may cover the front surface, the side, and a part of the rear surface of the mobile device, and the display unit may be positioned on the outer surface of the cover.

Without opening the cover of the mobile device, a state of the mobile device may be recognized through an image displayed on the outer surface of the cover.

A connection terminal may be formed on the side of the mobile device, the cover may be coupled with the mobile device through the contact pad portion, and the connection terminal may be formed at the center of the mobile device.

The cover may be coupled to be disposed at the inner side where the display unit contacts the mobile device, or coupled to be disposed at the outer side where the display unit does not contact the mobile device.

The cover may be connected to the side of the mobile device and configured to be woundable in a roll form and unwoundable from the roll form.

The cover may be configured to unwind from the roll form according to a required size of an image, and the cover may be configured to cover the front surface and the side of the mobile device in unrolled form.

The cover may cover the rear surface of the mobile device, and an image may be displayed on the rear surface of the mobile device through the display unit of the cover.

The cover may have an opening at a portion corresponding to a camera on the rear surface of the mobile device.

The cover may receive power from the mobile device.

The cover may be controlled by a driver of the mobile device.

The roof layer may include a color filter.

The display unit may include a common electrode positioned below the roof layer.

The display unit may include a common electrode that is insulated from the pixel electrode to be formed on the pixel electrode.

The display unit may include a capping layer sealing the microcavities.

The roof layer may fill a space between the liquid crystal layers formed by the plurality of microcavities to form a partition wall portion.

An inlet may be formed in a region where the partition wall portion is not formed.

The roof layer may include a color filter, and two kinds of color filters that are adjacent to each other may be filled in the partition wall portion.

As described above, according to the exemplary embodiment of the present disclosure, it is possible to use an appropriate display area according to a user's need by expanding the display area.

### BRIEF DESCRIPTION OF THE DRAWINGS

FIG. 1 illustrates a display device according to an exemplary embodiment of the present disclosure.

FIG. 2 illustrates a side of a mobile device of FIG. 1.

FIG. 3 illustrates a mobile device coupled with a cover according to an exemplary embodiment of the present disclosure.

FIG. 4 illustrates a case in which the cover is opened in the mobile device coupled with the cover according to an exemplary embodiment of the present disclosure.

FIG. 5 illustrates a display device coupled with a display unit to be disposed at an outer side.

FIGS. 6 and 7 illustrate covers according to an exemplary embodiment of the present disclosure.

FIGS. 8 and 9 illustrate the display devices according to an exemplary embodiment of the present disclosure.

FIG. 10 is a plan view illustrating the display unit of the cover according to an exemplary embodiment of the present disclosure.

FIG. 11 is a cross-sectional view of FIG. 10 taken along line XI-XI.

FIG. 12 is a cross-sectional view of FIG. 10 taken along line XII-XII.

FIG. 13 is a plan view illustrating the display unit of the cover according to an exemplary embodiment of the present disclosure.

FIG. 14 is a cross-sectional view of FIG. 13 taken along line XIV-XIV.

FIG. 15 is a cross-sectional view of FIG. 13 taken along line XV-XV.

### DETAILED DESCRIPTION OF THE EMBODIMENTS

The present disclosure is described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

In the drawings, the thickness of layers, films, panels, regions, etc., are exaggerated for clarity. Like reference numerals designate like elements throughout the specification. When an element such as a layer, film, region, or substrate is referred to as being “on” another element, it may be directly on the other element, or intervening elements may also be present. In contrast, when an element is referred to as being “directly on” another element, there are no intervening elements present.

Hereinafter, a display device according to an exemplary embodiment of the present disclosure is described in detail with reference to the accompanying drawings.

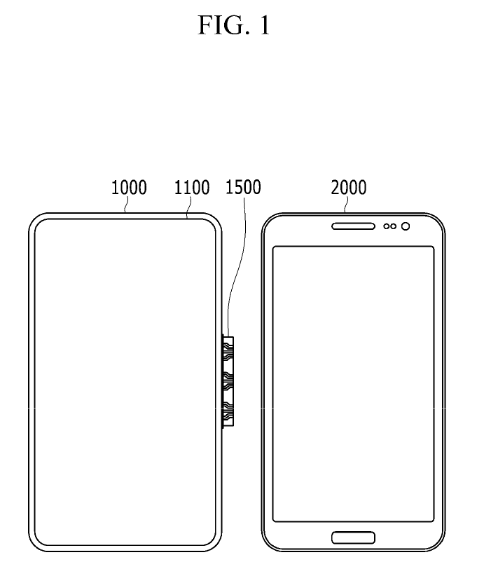

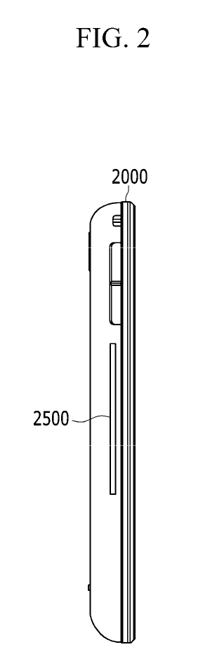

FIG. 1 illustrates a display device according to an exemplary embodiment of the present disclosure. FIG. 2 illustrates a side of a mobile device 2000 of FIG. 1.

Referring to FIG. 1, the display device according to the exemplary embodiment of the present disclosure includes the mobile device 2000 and a cover 1000 connected therewith.

The mobile device 2000 may be, for example, a general smart phone or a tablet PC as a communication terminal having portability, but is not limited thereto. The mobile device 2000 according to an exemplary embodiment of the present disclosure may be a smart phone.

The cover 1000 includes a display unit 1100 and a contact pad portion 1500. Contact wires are formed in the contact pad portion 1500.

A connection terminal 2500, which the contact pad portion 1500 contacts, is formed on the side of the mobile device 2000.

The contact pad portion 1500 of the cover 1000 couples with the connection terminal 2500 to connect the mobile device 2000 and the cover 1000 to each other.

In the cover 1000, a separate driver or power supply is not formed. The driver or power supply is formed in the mobile device 2000, and the cover 1000 receives power through the connection with the mobile device 2000. Accordingly, a thickness of the cover 1000 may be decreased, and a flexible characteristic may be maintained.

That is, in the display device according to an exemplary embodiment of the present disclosure, the cover 1000 and the mobile device 2000 are detachably connected to each other, and also electrically connected to each other through the connection terminal 2500 and the contact pad portion 1500.

The display unit 1100 of the cover 1000 is constituted by a flexible substrate, a roof layer facing the flexible substrate, and a liquid crystal layer formed between the substrate and the roof layer. That is, the display unit 1100 is a display device with a signal substrate having microcavities and is flexible. A detailed structure of the display unit 1100 is described below.

The cover 1000 according to an exemplary embodiment of the present disclosure is flexible and may protect the front surface, the side, and a part of the rear surface of the mobile device.

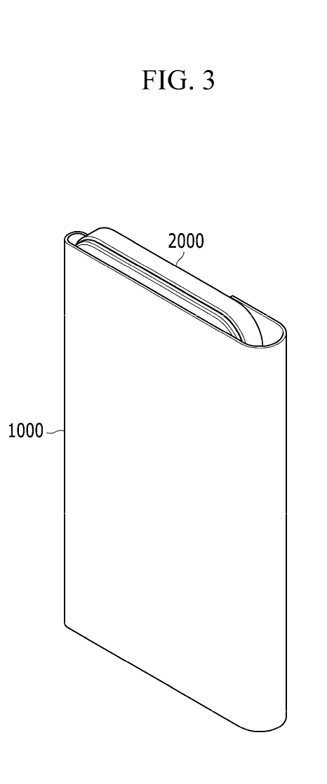

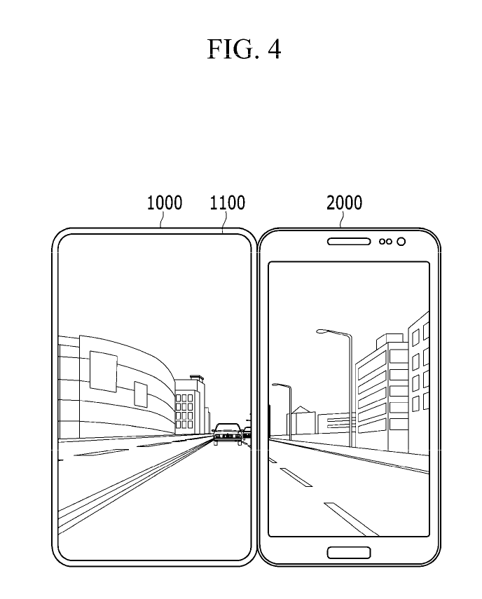

FIG. 3 illustrates a mobile device coupled with a cover according to an exemplary embodiment of the present disclosure. FIG. 4 illustrates a case in which the cover is opened in the mobile device coupled with the cover according to an exemplary embodiment of the present disclosure.

Referring to FIGS. 3 and 4, in the display device according to an exemplary embodiment of the present disclosure, the cover 1000 covers the front surface, the side, and a part of the rear surface of the mobile device 2000. As described above, since the cover 1000 is flexible, the cover 1000 may cover the side and the rear surface without a separate hinge.

Although not illustrated, the cover 1000 may cover only the front surface and the side of the mobile device 2000 in some cases.

Referring to FIG. 4, when the cover 1000 is opened, the display unit 1100 positioned inside the cover 1000 is exposed. In this case, an image displayed on the mobile device 2000 may be displayed to be extended and expanded to the display unit 1100 of the cover 1000. That is, the display unit 1100 may serve as an extension of the display area of the mobile device 2000 such that one portion of the image is displayed on the display area of the mobile device 2000 and a remaining portion of the image is displayed on the display unit 1100 to maintain visual continuity between the two image portions.

That is, a wide screen may not be implemented due to a limited display area of the mobile device 2000, but the mobile device according to an exemplary embodiment may implement a wide screen by applying the cover with the display unit 1100 formed therein.

Further, in the display device according to an exemplary embodiment of the present disclosure, the display unit 1100 of the cover 1000 may be coupled to be positioned outside.

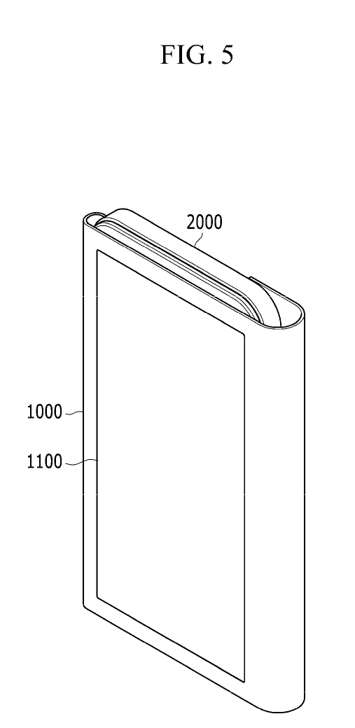

That is, referring to FIGS. 1 and 2, the contact pad portion 1500 of the cover 1000 and the connection terminal 2500 of the mobile device 2000 are formed at the center of the cover and the center of the mobile device. Accordingly, the display unit 1100 may change a position to be disposed on an inner side or an outer side of the mobile device 2000 in a direction of coupling the cover 1000 with the mobile device 2000. That is, the cover 1000 may be attached to the mobile device 2000 in a configuration in which, when the cover 1000 is in a closed position covering the display area of the mobile device, the display unit 1100 of the cover 1000 is outwardly exposed as shown in FIG. 5

FIG. 5 illustrates the display device in which the display unit 1100 is coupled to be disposed on the outer side of the cover. Referring to FIG. 5, the display unit 1100 of the cover is formed on the outer side of the cover 1000 covering the mobile device 2000. In the display unit 1100, the screen displayed in the display area of the mobile device 2000 may be equally expressed or briefly displayed.

Accordingly, in the case of the display device according to the embodiment of FIG. 5, a state and a signal of the mobile device 2000 may be recognized through the use of the display unit 1100 without opening the cover 1000.

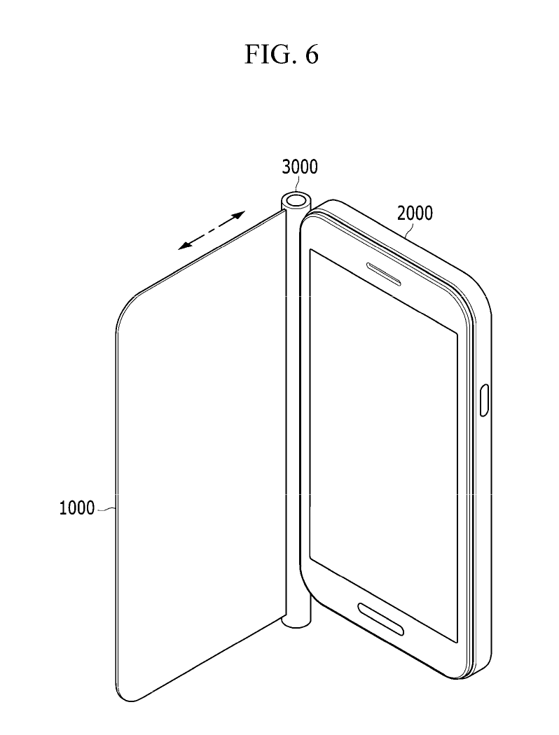

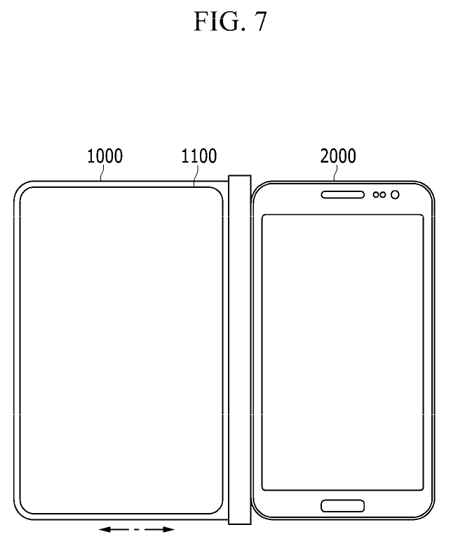

The flexible cover 1000 may be applied by various methods. FIGS. 6 and 7 illustrate a cover 1000 according to another exemplary embodiment of the present disclosure. The cover 1000 according to this exemplary embodiment is wound on a roller 3000 to be attached to the side of the mobile device 2000.

As illustrated in FIGS. 6 and 7, the cover 1000 may be wound on the roller 3000 when not being used and then be unwound and used when being used. According to a size of an image to be displayed, the cover 1000 is unwound by the size needed to be used to display the image. Further, the cover 1000 may be used to completely cover the front surface, the side, and the rear surface of the mobile device 2000.

The cover having the display function is coupled with the mobile device, thereby overcoming a limitation in which the existing mobile device has the limited display area and extending the display area.

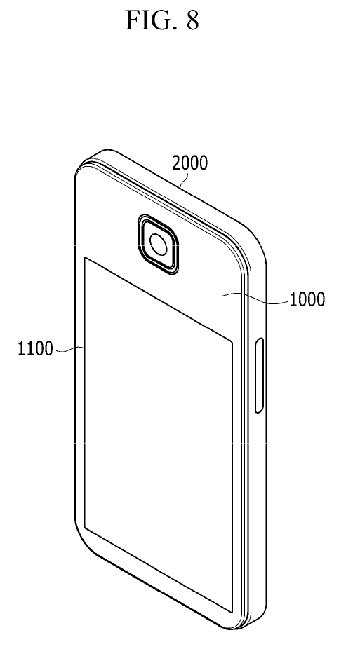

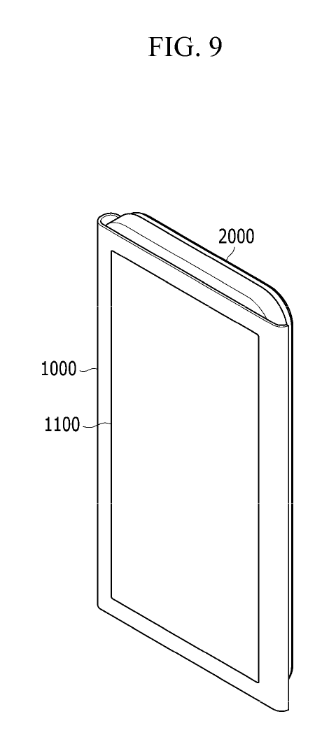

FIGS. 8 and 9 illustrate a display device according to an exemplary embodiment of the present disclosure. Referring to FIG. 8, in the display device according to the exemplary embodiment, a cover 1000 is installed on the rear surface of the mobile device and the display unit 1100 is formed on the cover. Accordingly, in the case of the display device according to the exemplary embodiment of FIG. 8, self-imaging may be performed by using a rear camera having good performance and the display unit 1100 of the cover.

The display device according to the exemplary embodiment of FIG. 9 is a display device in which the cover 1000 covers the rear surface of the mobile device 2000. In particular, the display unit 1100 of the cover 1000 is positioned on the rear surface of the mobile device 2000 and allows an image to be shared with a user positioned at an opposite side of the mobile device.

As such, in the display device according to an exemplary embodiment of the present disclosure, the display area is included in the cover, and the cover is flexible to be variously curved and used according to a user's need.

To implement the flexible cover display, the display unit of the cover according to an exemplary embodiment of the present disclosure is constituted by a single substrate and has a structure including microcavities. Hereinafter, a structure of the display unit is described in detail.

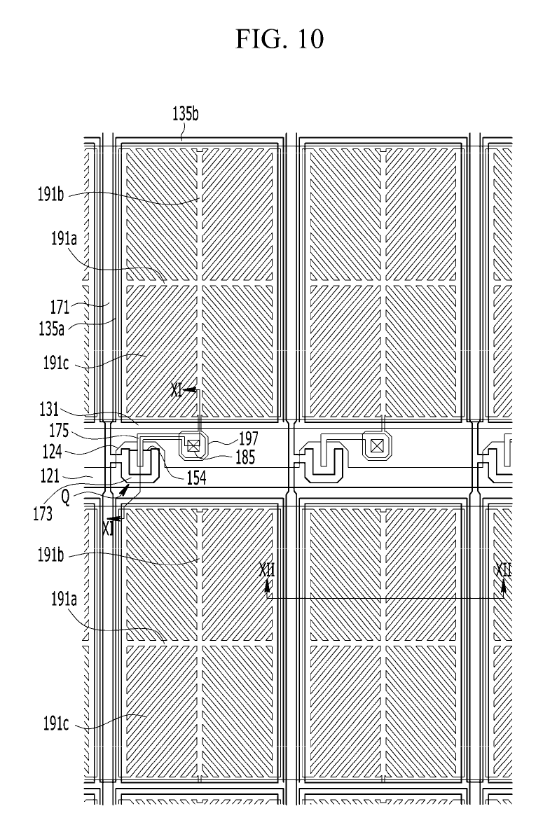

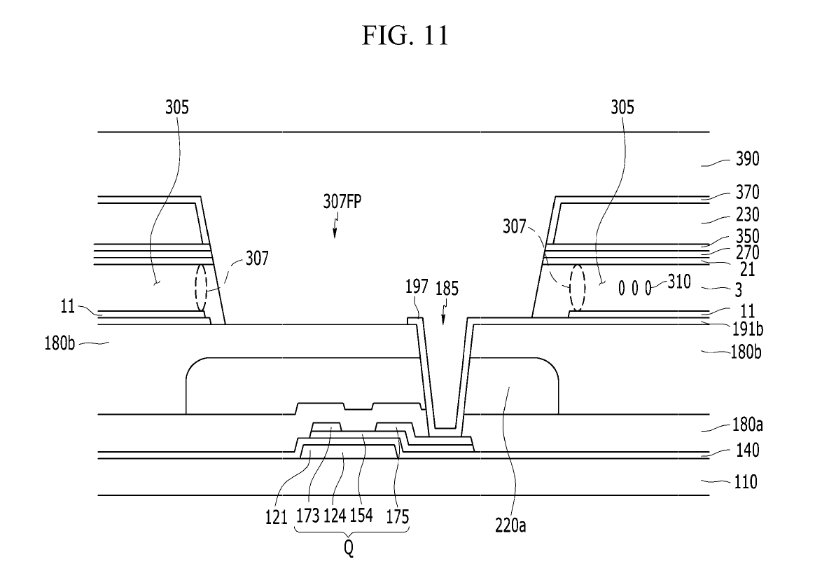

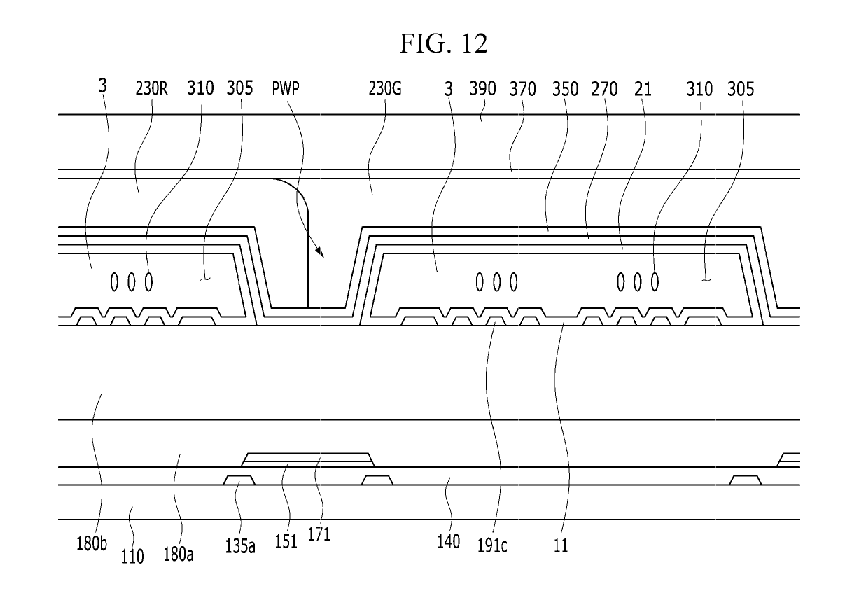

FIG. 10 is a plan view illustrating a part of the display unit of the cover according to an exemplary embodiment of the present disclosure. That is, the display unit of the cover includes pixels illustrated in FIG. 10, and a plurality of pixel rows and pixel columns are formed to represent the display unit. FIG. 11 is a cross-sectional view of FIG. 10 taken along line XI-XI. FIG. 12 is a cross-sectional view of FIG. 10 taken along line XII-XII.

Referring to FIGS. 10 to 12, a gate line 121 and a storage electrode line 131 are formed on a substrate 110 made of transparent plastic or the like.

The substrate 110 is made of transparent plastic and may be polyimide. The substrate 110 is made of a flexible material capable of being flexibly bent or curved.

Although not illustrated, a light guide plate may be positioned below the substrate 110. The light guide plate is formed with patterns guiding light in a predetermined direction and the like and also made of a flexible material capable of being flexibly bent or curved.

The gate line 121 includes a gate electrode 124. The storage electrode line 131 mainly extends in a horizontal direction and transfers a predetermined voltage such as a common voltage Vcom. The storage electrode line 131 includes a pair of vertical portions 135a extending to be substantially vertical to the gate line 121, and a horizontal portion 135b connecting ends of the pair of vertical portions 135a to each other. The vertical portions 135a and the horizontal portion 135b of the storage electrode line have a structure surrounding a pixel electrode 191.

A gate insulating layer 140 is formed on the gate line 121 and the storage electrode line 131. On the gate insulating layer 140, a lower semiconductor layer 151 positioned below a data line 171, and a semiconductor layer 154 positioned below source/drain electrodes and at a channel portion of a thin film transistor Q are formed.

A plurality of ohmic contacts (not shown) may be formed on the lower semiconductor layer 151 and the semiconductor layer 154, respectively, and between the data line 171 and the source/drain electrodes.

Data conductors 171, 173, and 175 including a source electrode 173, a data line 171 connected to the source electrode 173, and a drain electrodes 175 are formed on the lower semiconductor layer 151, the semiconductor layer 154, and the gate insulating layer 140, respectively.

The gate electrode 124, the source electrode 173, and the drain electrode 175 form a thin film transistor Q together with the semiconductor layer 154, and a channel of the thin film transistor Q is formed in the semiconductor layer 154 between the source electrode 173 and the drain electrode 175.

A first interlayer insulating layer 180a is formed on the data conductors 171, 173, and 175, and an exposed portion of the semiconductor layer 154. The first interlayer insulating layer 180a may be made of an inorganic insulating material, such as silicon nitride (SiNx) and silicon oxide (SiOx), or an organic insulating material.

A light blocking member 220a is formed on the first interlayer insulating layer 180a.

First, the light blocking member 220a is formed horizontally in a parallel direction with the gate line and made of a material which does not transmit light.

Although not illustrated, the light blocking member 220a may further include a vertical light blocking member formed in a parallel direction with the data line 171 in some cases.

A second interlayer insulating layer 180b is formed on the light blocking member 220a to cover the light blocking member 220a. The second interlayer insulating layer 180b may be made of an inorganic insulating material, such as silicon nitride (SiNx) and silicon oxide (SiOx), or an organic insulating material.

As illustrated in the cross-sectional view of FIG. 11, when a step is generated due to a thickness difference between a region with the light blocking member 220a and a region without the light blocking member 220a, the second interlayer insulating layer 180b includes an organic insulating material to reduce or remove the step. The second interlayer insulating layer may be omitted.

A contact hole 185 exposing the drain electrode 175 is formed in the light blocking member 220a and the interlayer insulating layers 180a and 180b.

The pixel electrode 191 is formed on the second interlayer insulating layer 180b.

The pixel electrode 191 has an overall shape of a quadrangle, includes a cross stem constituted by a horizontal stem 191a and a vertical stem 191b crossing the horizontal stem 191a, and includes a plurality of minute branches 191c protruding from the cross stem.

Further, in the exemplary embodiment, the pixel electrode 191 may further include an outer stem surrounding the outside of the pixel electrode 191.

The minute branches 191c of the pixel electrode 191 form an angle of approximately 40° to 45° with the gate line 121 or the horizontal stem 191a. Further, the minute branches of two adjacent domains may be perpendicular to each other. Further, widths of the minute branches may be gradually increased, or distances between the minute branches 191c may be different from each other.

The pixel electrode 191 includes an extension 197 that is connected to a lower end of the vertical stem 191b and has a larger area than the vertical stem 191b, and is physically and electrically connected with the drain electrode 175 through the contact hole 185 at the extension 197 to receive a data voltage from the drain electrode 175.

The description of the thin film transistor Q and the pixel electrode 191 described above up to now are just examples, and a structure of the thin film transistor and a design of the pixel electrode may be modified in order to improve side visibility.

A first alignment layer 11 is formed on the pixel electrode 191 and may be a vertical alignment layer. The first alignment layer 11 may be formed by including at least one of materials that are generally used as a liquid crystal alignment layer, such as polyamic acid, polysiloxane, polyimide, or the like.

A second alignment layer 21 is positioned at a portion facing the first alignment layer 11, and a plurality of microcavities 305 is formed between the first alignment layer 11 and the second alignment layer 21. A liquid crystal layer 3 is positioned in the plurality of microcavities 305. The first alignment layer 11 and the second alignment layer 21 may be connected to each other at the side of the microcavity to substantially form one alignment layer.

A liquid crystal material including liquid crystal molecules 310 is injected into the microcavities 305 to form a liquid crystal layer 3. An inlet 307 is positioned at the edge of the microcavities 305, and the inlet 307 may be covered by a capping layer 390 to be described below after an alignment material and a liquid crystal material are injected. The microcavities 305 may be formed in a column direction, that is, a vertical direction of the pixel electrode 191. In the exemplary embodiment, the alignment material forming the alignment layers 11 and 21 and the liquid crystal material including the liquid crystal molecules 310 may be injected into the microcavities 305 by using capillary force.

The microcavities 305 are divided in a vertical direction by a plurality of liquid crystal injection hole formation portions 307FP positioned at the portion overlapping with the gate line 121, and further, a plurality of microcavities is formed in an extending direction of the gate line 121. Each of the plurality of microcavities 305 may correspond to one pixel area or two or more pixel areas, and the pixel area may correspond to an area displaying an image.

A common electrode 270 and a first insulating layer 350 are positioned on the second alignment layer 21. The common electrode 270 receives a common voltage and generates an electric field together with the pixel electrode 191 to which a data voltage is applied to determine tilt directions of the liquid crystal molecules 310 positioned in the microcavities 305 between the two electrodes. The common electrode 270 forms a capacitor together with the pixel electrode 191 to maintain the applied voltage even after the thin film transistor is turned off. The first insulating layer 350 may be formed of silicon nitride (SiNₓ) or silicon oxide (SiO₂).

In the exemplary embodiment, the common electrode 270 is formed on the microcavity 305, but in another exemplary embodiment, the common electrode 270 may be formed below the microcavity 305, and thus, the liquid crystal may be driven according to an in-plane switching mode.

A color filter layer 230 is positioned on the first insulating layer 350. The color filter layer 230 performs the same function as the roof layer and serves to support the microcavity 305, which is a space between the pixel electrode 191 and the common electrode 270.

In this case, the color filter layer 230 may display one of the primary colors such as three primary colors of red, green and blue. However, the color filter layer 230 may display one of cyan, magenta, yellow, and white-based colors without being limited to the three primary colors of red, green and blue. The color filter layer 230 may be made of a material displaying different colors for every adjacent pixel. In the drawing of this specification, a red color filter, a green color filter, and a blue color filter are represented by 230R, 230G, and 230B, respectively, but are not limited to the colors illustrated in the drawing. Further, in this specification, the color filter layer 230 may be used as a super ordinate concept covering 230R, 230G, and 230B.

A second insulating layer 370 is positioned on the color filter layer 230. The second insulating layer 370 may contact an upper surface of the color filter layer 230. The second insulating layer 370 may be formed of silicon nitride (SiNₓ) or silicon oxide (SiO₂).

In the exemplary embodiment, a capping layer 390 fills the liquid crystal injection hole formation portion 307FP and covers a liquid crystal injection hole 307 of the microcavity 305 exposed by the liquid crystal injection hole formation portion 307FP. The capping layer 390 includes an organic material or an inorganic material.

In the exemplary embodiment, as illustrated in FIG. 12, a partition wall portion PWP is formed between the microcavities 305 adjacent to each other in a horizontal direction. The partition wall portion PWP may be formed in an extending direction of the data line 171 and covered by the adjacent color filter layer 230. The first insulating layer 350, the common electrode 270, the second insulating layer 370, and the color filter layer 230 are filled in the partition wall portion PWP, and the structure may form a partition wall to partition or define the microcavities 305. In the exemplary embodiment, since a partition wall structure, such as the partition wall portion PWP, exists between the microcavities 305, even though the insulation substrate 110 is bent, generated stress is small, and a change in degree of a cell gap may be much reduced.

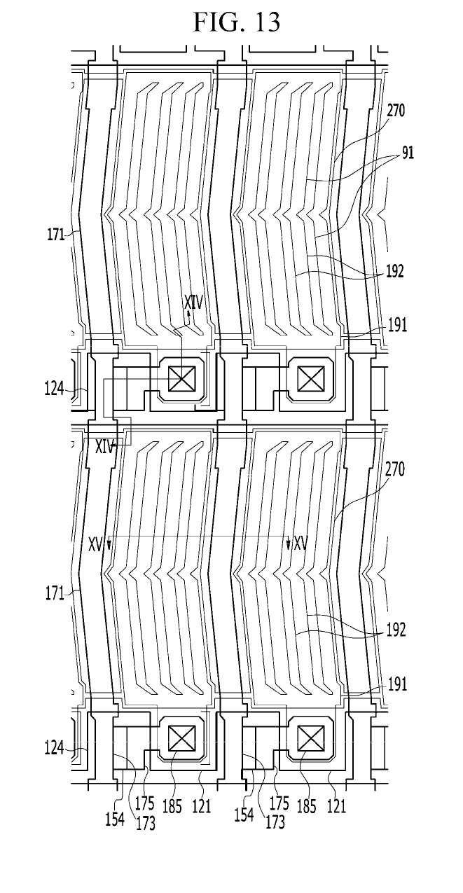

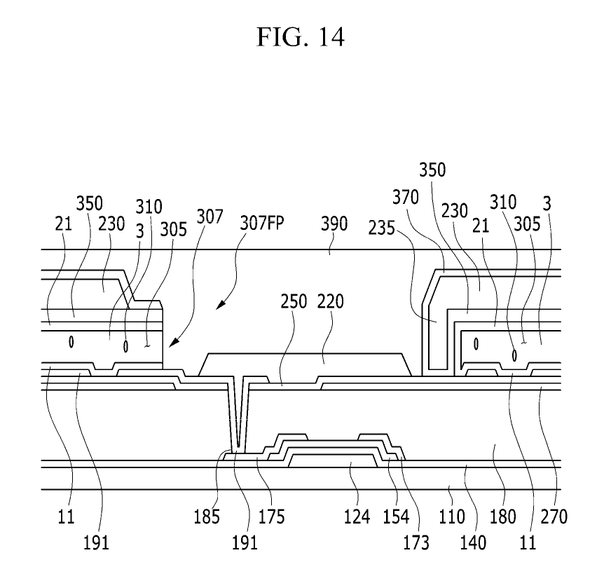

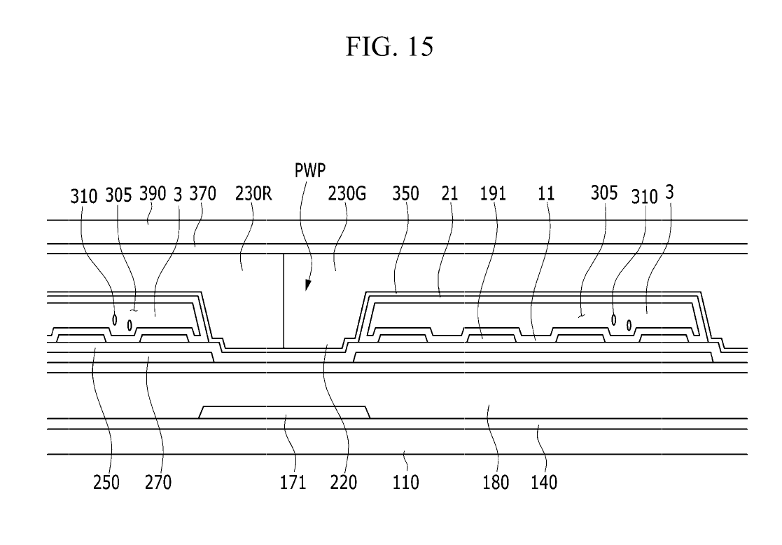

Alternatively, the display unit of the cover according to an exemplary embodiment of the present disclosure may have the following structure. FIG. 13 is a plan view illustrating the display unit of the cover according to an exemplary embodiment of the present disclosure. FIG. 14 is a cross-sectional view of FIG. 13 taken along line XIV-XIV. FIG. 15 is a cross-sectional view of FIG. 13 taken along line XV-XV.

Hereinafter, a display device according to an exemplary embodiment of the present disclosure is described in detail with reference to FIGS. 13 to 15.

First, a gate conductor including a gate line 121 is formed on an insulation substrate 110 made of transparent plastic or the like.

A gate line 121 includes a gate electrode 124 and a wide end portion (not illustrated) for connecting with another layer or an external driving circuit. The gate line 121 may be made of aluminum-based metal such as aluminum (Al) or an aluminum alloy, silver-based metal such as silver (Ag) or a silver alloy, copper-based metal such as copper (Cu) or a copper alloy, molybdenum-based metal such as molybdenum (Mo) or a molybdenum alloy, chromium (Cr), tantalum (Ta), titanium (Ti), and the like. However, the gate line 121 may have a multilayered structure including at least two conductive layers having different physical properties.

A gate insulating layer 140 made of silicon nitride (SiNx), silicon oxide (SiO₂), or the like is formed on the gate line 121. The gate insulating layer 140 may have a multilayered structure including at least two insulating layers having different physical properties.

A semiconductor layer 154 made of amorphous silicon or polysilicon is formed on the gate insulating layer 140. The semiconductor layer 154 may include an oxide semiconductor.

An ohmic contact (not illustrated) is formed on the semiconductor layer 154. Ohmic contacts (not illustrated) may be made of a material such as n+ hydrogenated amorphous silicon in which an n-type impurity such as phosphorus is doped at a high concentration, or silicide. The ohmic contacts (not illustrated) may be disposed on the semiconductor layer 154 to make a pair. In the case in which semiconductor layer 154 is an oxide semiconductor, the ohmic contacts may be omitted.

A data conductor including a data line 171 including a source electrode 173 and a drain electrode 175 is formed on the semiconductor layer 154 and the gate insulating layer 140.

The data line 171 includes a wide end portion (not illustrated) for connecting with another layer or an external driving circuit. The data line 171 transfers a data signal and mainly extends in a vertical direction to cross the gate line 121.

In this case, the data line 171 may have a first curved portion having a curved shape to obtain maximum transmittance of the liquid crystal display, and the curved portions may meet each other in a middle region of the pixel area to form a V shape. A second curved portion that is curved to form a predetermined angle with the first curved portion may be further included in the middle region of the pixel area.

The source electrode 173 is a part of the data line 171 and disposed on the same line as the data line 171. The drain electrode 175 is formed to extend in parallel with the source electrode 173. Accordingly, the drain electrode 175 is parallel with a part of the data line 171.

The gate electrode 124, the source electrode 173, and the drain electrode 175 form a thin film transistor (TFT) together with the semiconductor layer 154, and a channel of the thin film transistor is formed in the semiconductor layer 154 between the source electrode 173 and the drain electrode 175.

The data line 171 and the drain electrode 175 may be made of a refractory metal, such as molybdenum, chromium, tantalum, and titanium or an alloy thereof, and have a multilayered structure including a refractory metal layer (not illustrated) and a low resistive conductive layer (not illustrated). An example of the multilayer structure may include a double layer of a chromium or molybdenum (alloy) lower layer and an aluminum (alloy) upper layer, and a triple layer of a molybdenum (alloy) lower layer, an aluminum (alloy) intermediate layer, and a molybdenum (alloy) upper layer. However, the data line 171 and the drain electrode 175 may be made of various metals or conductors other than the metals.

A passivation layer 180 is disposed on the data conductors 171, 173, and 175, the gate insulating layer 140, and an exposed portion of the semiconductor layer 154. The passivation layer 180 may be made of an inorganic insulating material or an organic insulating material.

The passivation layer 180 has a contact hole 185.

A common electrode 270 is positioned on the passivation layer 180. The common electrode 270 may have a planar shape and is disposed in the display area where the plurality of pixels is positioned, but is not positioned in a peripheral area where a gate pad portion or a data pad portion is formed.

The common electrode 270 is formed of a transparent conductive layer such as ITO or IZO.

An insulating layer 250 is positioned on the common electrode 270. The insulating layer 250 may be made of an inorganic insulating material such as silicon nitride (SiNx), silicon oxide (SiOx), and silicon oxynitride (SiOxNy). The insulating layer 250 serves to protect the color filter layer 230 made of the organic material and insulate the common electrode 270 and the pixel electrode 191 from each other. That is, even though the common electrode 270 is formed to overlap with the pixel electrode 191, the insulating layer 250 is formed on the common electrode 270 to prevent the common electrode 270 and the pixel electrode 191 from being short-circuited by contacting each other.

The pixel electrode 191 is positioned on the insulating layer 250. The pixel electrode 191 has a plurality of first cutouts 91 and includes a plurality of first branch electrodes 192 defined by the plurality of first cutouts 91.

The pixel electrode 191 may be formed of a transparent conductive layer such as ITO or IZO.

The pixel electrode 191 is physically and electrically connected with the drain electrode 175 through the contact hole 185 formed in the passivation layer 180 to receive a voltage from the drain electrode 175.

The pixel electrode 191 receives a data voltage from the drain electrode 175, and the common electrode 270 receives a reference voltage having a predetermined magnitude from a reference voltage applying unit disposed outside the display area.

The pixel electrode 191 and the common electrode 270 generate an electric field according to the applied voltage, and the liquid crystal molecules 310 of the liquid crystal layer 3 positioned on the two electrodes 191 and 270 rotate in a parallel direction with the direction of the electric field. Polarization of light passing through the liquid crystal layer varies according to the rotation directions of the liquid crystal molecules determined as described above.

A first insulating layer 350 may be further formed on the pixel electrode 191 so as to be spaced apart from the pixel electrode 191 at a predetermined distance. The first insulating layer 350 may be made of an inorganic insulating material such as silicon nitride (SiNx) and silicon oxide (SiOx).

A plurality of microcavities 305 is formed between the pixel electrode 191 and the first insulating layer 350. That is, the microcavities 305 are surrounded by the pixel electrode 191 and the first insulating layer 350. The liquid crystal layer 3 is positioned in the plurality of microcavities 305. A width and an area of the microcavity 305 may be variously modified according to a size and a resolution of the display device.

A first alignment layer 11 is formed on the pixel electrode 191. The first alignment layer 11 may be formed directly on portions of the first insulating layer 250 that are not covered by the pixel electrode 191.

A second alignment layer 21 is formed below the first insulating layer 350 so as to face the first alignment layer 11.

The first alignment layer 11 and the second alignment layer 21 may be formed by vertical alignment layers and made of alignment materials such as polyamic acid, polysiloxane, and polyimide. The first and second alignment layers 11 and 21 may be connected to each other at the edge of the pixel area as illustrated in FIG. 14.

Further, a light blocking member 220 is formed in a parallel direction with the gate line, and particularly, may be positioned on the pixel electrode 191 and portions of the insulating layer 250 not covered by the pixel electrode, as illustrated in FIG. 14. The light blocking member 220 is formed on a boundary of the pixel area and the thin film transistor to prevent light leakage.

The light blocking member 220 extends along the gate line 121. Further, additionally, although not illustrated, the light blocking member 220 may include a vertical light blocking member extending along the data line 171. That is, a horizontal light blocking member is formed at a liquid crystal injection hole formation portion 307FP, and the vertical light blocking member may be formed at a partition wall portion PWP. However, the vertical light blocking member may be omitted. A width of the data line 171 is extended, and thus, the data line 171 may serve as the vertical light blocking member.

Next, a color filter layer 230 is formed on the first insulating layer 350. The color filter layer 230 may display one of the primary colors such as three primary colors of red, green and blue. The color filter layer 230 is not limited to the three primary colors of red, green and blue, but may also display one of cyan, magenta, yellow, and white-based colors.

The microcavity 305 is formed below the color filter layer 230, and the color filter layer 230 is hardened by a curing process to maintain the shape of the microcavity 305. The color filter layer 230 is formed to be spaced apart from the pixel electrode 191 with the microcavity 305 therebetween.

The color filter layers 230 are formed in each pixel area and the partition wall portion PWP along a pixel row and are not formed in the liquid crystal injection hole formation portion 307FP. The microcavity 305 is not formed below the color filter layer 230 in the partition wall portion PWP. Accordingly, a thickness of the color filter layer 230 positioned at the partition wall portion PWP may be larger than the thickness of the color filter layer 230 positioned in the pixel area. An upper surface and both sides of the microcavity 305 are formed to be covered by the color filter layer 230.

An inlet 307 exposing a part of the microcavity 305 is formed in the color filter layer 230. The first insulating layer 350 adjacent to the region with the inlet 307 is formed may include a region which further protrudes than the color filter layer 230.

The inlet 307 according to an exemplary embodiment of the present disclosure may be formed at one edge of the pixel area. For example, the inlet 307 corresponds to a lower side of the pixel area to expose one surface of the microcavity 305. Alternatively, of course, the inlet 307 may be formed to correspond to an upper side of the pixel area.

Further, when a formation position of the inlet 307 is described with respect to the microcavity 305, the inlet 307 may be formed at any one of two edges of each microcavity 305 facing each other.

A support member 235 formed by a part of the color filter layer 230 is formed at a portion without the inlet 307.

Since the microcavity 305 is exposed by the inlet 307, an aligning agent, a liquid crystal material, or the like may be injected into the microcavity 305 through the inlet 307.

A second insulating layer 370 may be further formed on the color filter layer 230. The second insulating layer 370 may be made of an inorganic insulating material such as silicon nitride (SiNx) and silicon oxide (SiOx). The second insulating layer 370 may be formed to cover an upper surface and a side of the color filter layer 230. The second insulating layer 370 serves to protect the color filter layer 230 made of an organic material and may be omitted in some cases.

The second insulating layer 370 may contact the first insulating layer 350, which further protrudes than the color filter layer 230 in the region where the inlet 307 is positioned. Further, the second insulating layer 370 may have a stepped cross section by a step between the region contacting the first insulating layer 350 and the region covering the color filter layer.

Further, the second insulating layer 370 may be connected with the first insulating layer 350. The second insulating layer 370 may be connected or overlap with the first insulating layer 350 at an opposite position corresponding to the inlet 307, that is, in the region where the support member 235 is positioned.

The capping layer 390 may be formed on the second insulating layer 370. The capping layer 390 is formed to cover the inlet 307 exposing a part of the microcavity 305 to the outside. That is, the capping layer 390 may seal the microcavity 305 so as to prevent the liquid crystal molecules 310 formed inside the microcavity 305 from being leaked to the outside. Since the capping layer 390 contacts the liquid crystal molecules 310, the capping layer 390 may be made of a material that does not react with liquid crystal molecules 310. For example, the capping layer 390 may be made of parylene and the like.

The capping layer 390 may be formed as a multilayer such as a double layer and a triple layer. The double layer is configured by two layers made of different materials. The triple layer is configured by three layers, and materials of adjacent layers are different from each other. For example, the capping layer 390 may include a layer made of an organic insulating material and a layer made of an inorganic insulating material.

Although not illustrated, polarizers may be further formed on upper and lower surfaces of the display device. The polarizers may be constituted by a first polarizer and a second polarizer. The first polarizer may be attached to the lower surface of the substrate 110, and the second polarizer may be attached to the capping layer 390.

As such, a display device according to exemplary embodiments of the present disclosure includes the mobile device and the cover connected thereto, and the display unit is formed in the cover. The display unit of the cover has the structure in which microcavities are formed on the single substrate having the flexible characteristic to maintain display quality even in the case of curving or rolling.

Generally, there is a problem in that the existing mobile device may not display a wide screen due to the limited display area. However, the display device according to the exemplary embodiments solves the problem by adding the display function to the cover of the mobile device. Further, the cover of the present disclosure has a flexible characteristic to be freely curved or unfolded, and the cover is electrically connected with the mobile device to receive the power or driving system from the mobile device, and thus the thickness of the cover may be decreased.

While the present disclosure includes descriptions of exemplary embodiments, it is not limited to the disclosed embodiments. On the contrary, the present disclosure is intended to cover various modifications and equivalent arrangements included within the spirit and scope of the appended claims.

<Description of symbols>

| | | | |
|---|---|---|---|
| 1000: | Cover | 2000: | Mobile device |
| 3000: | Roller | 1100: | Display unit |
| 11: | First alignment layer | 21: | Second alignment layer |
| 110: | Substrate | 180: | Passivation layer |
| 121: | Gate line | 171: | Data line |
| 154: | Semiconductor layer | 220: | Light blocking member |
| 230: | Color filter layer | 250: | Insulating layer |
| 350: | First insulating layer | 310: | Liquid crystal molecule |
| 370: | Second insulating layer | 390: | Capping layer |

What is claimed is:

1. A display device, comprising:
a mobile device and a cover connected thereto,
wherein the cover includes a contact pad portion and a display unit that are connected with an external power supply,
the display unit includes:
a flexible substrate;
a pixel electrode positioned on the flexible substrate;
a roof layer facing the pixel electrode; and
a liquid crystal layer formed by a plurality of microcavities including liquid crystal molecules between the pixel electrode and the roof layer, and
the cover is connected to a surface of the mobile device to cover the front surface and the rear surface of the mobile device.

2. The display device of claim 1, wherein:
the cover covers the front surface, the side, and a part of the rear surface of the mobile device, and
the display unit is positioned on the inner surface of the cover.

3. The display device of claim 1, wherein:
the mobile device is configured to display a first portion of an image, and the display unit is configured to display a second portion of the image such that visual continuity between the two image portions is maintained.

4. The display device of claim 2, wherein:
the cover covers the front surface, the side, and a part of the rear surface of the mobile device, and
the display unit is positioned on the outer surface of the cover.

5. The display device of claim 4, wherein:
without opening the cover of the mobile device,
a state of the mobile device is recognized through an image displayed on the outer surface of the cover.

6. The display device of claim 1, wherein:
a connection terminal is formed on the side of the mobile device,
the cover is coupled with the mobile device through the contact pad portion, and
the connection terminal is formed at the center of the mobile device.

7. The display device of claim 6, wherein:
the cover is coupled to be disposed at the inner side where the display unit contacts the mobile device, or
is coupled to be disposed at the outer side where the display unit does not contact the mobile device.

8. The display device of claim 1, wherein:
the cover is connected to the side of the mobile device and configured to be woundable in a roll form and unwoundable from the roll form.

9. The display device of claim 8, wherein:
the cover is configured to unwind from the roll form according to a required size of an image to be displayed, and
the cover is configured to cover the front surface and the side of the mobile device in unrolled form.

10. The display device of claim 1, wherein:
the cover covers the rear surface of the mobile device, and
an image is displayed on the rear surface of the mobile device through the display unit of the cover.

11. The display device of claim 10, wherein:
the cover has an opening at a portion corresponding to a camera on the rear surface of the mobile device.

12. The display device of claim 1, wherein:
the cover receives power from the mobile device.

13. The display device of claim 1, wherein:
the cover is controlled by a driver of the mobile device.

14. The display device of claim 1, wherein:
the roof layer includes a color filter.

15. The display device of claim 1, wherein:
the display unit includes a common electrode positioned below the roof layer.

16. The display device of claim 1, wherein:
the display unit includes a common electrode that is insulated from the pixel electrode to be formed on the pixel electrode.

17. The display device of claim 1, wherein:
the display unit includes a capping layer sealing the microcavities.

18. The display device of claim 1, wherein:
the roof layer fills a space between the liquid crystal layers formed by the plurality of microcavities to form a partition wall portion.

19. The display device of claim 1, wherein:
an inlet is formed in a region where the partition wall portion is not formed.

20. The display device of claim 18, wherein:
the roof layer includes a color filter, and two kinds of color filters that are adjacent to each other are filled in the partition wall portion.
